(19) United States
(12) Patent Application Publication
(10) Pub. No.: US 2009/0009648 A1
(43) Pub. Date: Jan. 8, 2009

(54) Display device having camera

(75) Inventor: Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/217,326

(22) Filed: Jul. 2, 2008

(30) Foreign Application Priority Data
Jul. 6, 2007 (CN) 200710075838.7

(51) Int. Cl. H04N 5/222

(52) U.S. Cl. 348/333.01; 348/E05.022

(57) ABSTRACT

An exemplary display device includes a monitor, a camera, a comparison circuit connected to the camera, and a control circuit connected to the control circuit and the monitor. The camera is capable of capturing a plurality of instantaneously captured images. The comparison circuit is capable of generating a positive result when one of the instantaneously captured images matches a pre-stored reference image, and generating a negative result when no instantaneously captured images match the reference image. The control circuit is configured for generating a first instruction to turn on the monitor according to the positive comparison result and to turn off the monitor according to the negative comparison result.

### FIELD OF THE INVENTION

The present invention relates to display devices, and more particularly to a display device having a camera for power management.

### BACKGROUND

A display device is often used with an apparatus such as a computer to display data and operations generated thereby. Most popular display devices can be classified to cathode ray tube (CRT) devices and liquid crystal display (LCD) devices. Because LCDs have the advantages of portability, low power consumption, and low radiation, they have been more and more widely used in various display devices such as notebooks, personal digital assistants (PDAs), video cameras, and the like.

In general, to power off a typical display device, a manual operation is needed. Such manual operation usually triggers a mechanism such as a button or a contact pad, terminating power supply to the display device. If the display device is inactive or idle, such as a user leaving the device running, power supply to the display device is wasted. Even so, it is troublesome to turn off the display device manually whenever a user leaves the display device temporarily.

What is needed, therefore, is a display device that can overcome the described shortcomings.

### SUMMARY

In one preferred embodiment, a display device includes a monitor, a camera, a comparison circuit connected to the camera, and a control circuit connected to the comparison circuit and the monitor. The camera is capable of capturing a plurality of images instantaneously. The comparison circuit is capable of generating a positive result when any one of the instantaneously captured images matches a pre-stored reference image, and generating a negative result when no instantaneously captured images match the reference image. The control circuit is configured for generating a first instruction to turn on the monitor according to a positive comparison result and to turn off the monitor according to a negative comparison result.

Other novel features and advantages will become more apparent from the following detailed description when taken in conjunction with the accompanying drawings.

### BRIEF DESCRIPTION OF THE DRAWINGS

FIG. 1 is a block diagram of a display device according to a first embodiment of the present invention, the display device including a comparison circuit.

FIG. 2 is a block diagram illustrating the comparison circuit of FIG. 1.

FIG. 3 is a block diagram of a display device according to a second embodiment of the present invention.

### DETAILED DESCRIPTION OF PREFERRED EMBODIMENTS

Referring to FIG. 1, a block diagram of a display device 20 according to a first embodiment of the present invention is shown. The display device 20 includes a power source 21, a control circuit 22, a comparison circuit 26, a switch 25, a camera 24, and a liquid crystal display 23. The control circuit 22, the liquid crystal display 23, the comparison circuit 26, the switch 25, and the camera 24 are connected to the power source 21, respectively. The camera 24 is connected to the comparison circuit 26. The switch 25 is connected to the comparison circuit 26. The comparison circuit 26 is connected to the liquid crystal display 23.

The camera 24 captures real-time images and generates corresponding image data to the comparison circuit 26. The comparison circuit 26 compares image data corresponding to real-time images to pre-stored data corresponding to a reference image, and sends a comparison result to the control circuit 22. The control circuit 22 generates an instruction to turn on or turn off the liquid crystal display 23 according to the comparison result from the comparison circuit 26. The liquid crystal display 23 displays images according to external data signals. The power source 21 powers the control circuit 22, the liquid crystal display 23, the camera 24, the switch 25, and the comparison circuit 26. The switch 25 is capable of allowing the camera to capture the reference image instantaneously and storing data corresponding to the reference image into the comparison circuit 26 when a user of the display device 20 operates the switch 25.

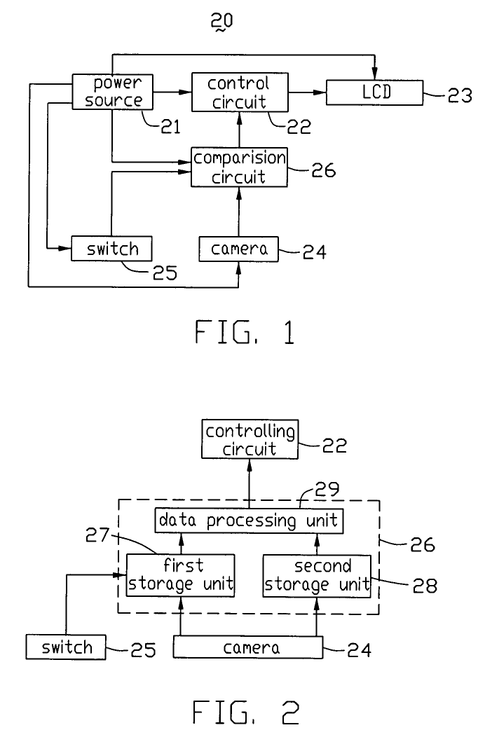

Referring also to FIG. 2, a block diagram illustrating the comparison circuit 26 is shown. The comparison circuit 26 includes a first storage unit 27, a second storage unit 28, and a data processing unit 29. The first storage unit 27 is electrically connected to the switch 25, the camera 24, and the data processing unit 29. The second storage unit 28 is electrically connected to the camera 24 and the data processing unit 29. The data processing unit 29 is connected to the control circuit 22.

The first storage unit 27 stores data corresponding to the reference image when the switch 25 is operated. The second storage unit 28 stores data corresponding to the images captured by the camera 24. The data processing unit 29 is capable of comparing the data stored in the first and second storage units 27, 28 to generate a comparison result. The comparison result can be positive, indicating that the captured image approximately matches the reference image, or negative, indicating that the captured image does not match the reference image. The data processing unit 29 can include a built-in integrated circuit (not shown) processing and comparing the data stored in the first and second storage units 27, 28, and the comparison of the integrated circuit can incorporate a predetermined “similarity extent”. That is, when a part of the data stored in the first and second storage units 27, 28 complies with the “similarity extent”, the comparison result is positive, and otherwise the comparison result is negative.

The reference image can, for example, comprise an image of the user while using the display device 20. The camera 24 is set to capture the real-time images regularly and periodically. For example, the camera 24 can capture one image per 30 seconds. The data processing unit 29 is set to compare the data stored in the first storage unit 27 to data stored the second storage unit 28 periodically. A cycle span of the comparing process usually exceeds a cycle span of the capture. The first storage unit 27 is re-written to when data corresponding to a reference image is stored by manual user operation of the switch 25. The second storage unit 28 is re-written to, storing data each time an image is an instantaneously captured. That is, the first and second storage units 27, 28 store the latest captured images, respectively.

Operation of the display device 20 is detailed as follows. The user of the display device 20 operates the switch 25, so that the camera 24 captures a reference image. Data corresponding to the reference image is stored into the first storage unit 27. The camera 24 instantaneously captures an image and data corresponding thereto is stored into the second storage unit 28. The comparison circuit 26 compares the data stored in the first storage unit 27 to the data stored in the second storage unit 28, generating a comparison result to the control circuit 22. If the comparison result indicates a reference image match with the instantaneously captured image, the comparison circuit 26 generates a positive comparison result to the control circuit 22, which in turn generates a first instruction to turn on the liquid crystal display 23. If the comparison result indicates no reference image match with the instantaneously captured image, the comparison circuit 26 generates a negative comparison result, according to which the control circuit 22 generates a second instruction to turn off the liquid crystal display 23.

In summary, the display device 20 includes a camera 24, the comparison circuit 26, and control circuit 22, and is capable of turning on or turning off the liquid crystal display 23 automatically according to the comparison result of data of the reference image and a instantaneously captured image. Thus power consumption of the liquid crystal display 23 is reduced when the liquid crystal display 23 is idle or inactive.

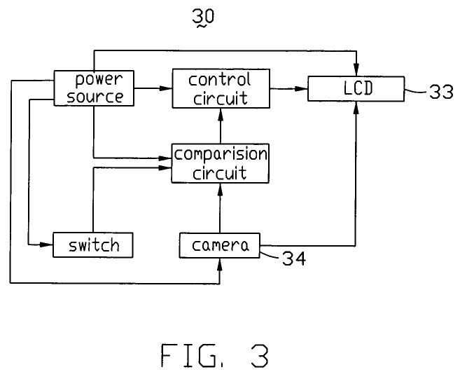

Referring to FIG. 3, a block diagram of a display device 30 according to a second embodiment of the present invention is shown. The display device is similar to the display device 20, differing only in that a camera 30 is further connected to a liquid crystal display 33. Thus, instantaneously captured images captured by the camera 34 can be displayed in a liquid crystal display 33.

Alternative and exemplary embodiments may include the following. In a first example, the first storage unit 27 of comparison circuit 26 can store data corresponding to a number of reference images featuring different users of the display device 20, respectively. The comparison circuit 26 can compare data corresponding to the instantaneously captured image to data in corresponding reference images, respectively, making the display device 20 available to different authorized users in extended application. In a second example, the control circuit 22 is integrated into the comparison circuit 26, which may both fabricated on one printed circuit board. In a third example, the switch 25 can be omitted, and reference image storage achieved by application software. In a fourth example, the liquid crystal display may also be a cathode ray tube display.

It is to be further understood that even though numerous characters and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A display device comprising:
a liquid crystal display;
a camera capable of capturing at least one reference image and at least one instantaneously captured image; and
a comparison circuit connected to the liquid crystal display and the camera;
wherein the comparison circuit is capable of turning the liquid crystal display on when the at least one reference image matches the at least one instantaneously captured image, and turning the liquid crystal display off when the at least one reference image does not match the at least one instantaneously captured image.

2. The display device of claim 1, wherein the camera is capable of sending data corresponding to the at least one reference image to the comparison circuit when capturing the at least one reference image, and sending data corresponding to the at least one instantaneously captured image to the comparison circuit when capturing the at least one instantaneously captured image.

3. The display device of claim 1, wherein the comparison circuit compares data corresponding to the at least one reference image to data corresponding to the at least one instantaneously captured image, respectively, and generates a control signal to the liquid crystal display according to the comparison result.

4. The display device of claim 1, wherein the comparison circuit comprises a first storage unit configured to store data corresponding to the at least one reference image, a second storage unit configured to store data corresponding to the at least one instantaneously captured image.

5. The display device of claim 4, wherein the comparison circuit further comprises a data processing unit configured for comparing data stored in the first storage unit to data stored in the second storage unit, and generating a control signal to the liquid crystal display according to the comparison result to turn on or turn off the liquid crystal display.

6. The display device of claim 5, wherein the camera is set to periodically capture a plurality of instantaneously captured images, and the comparison circuit is set to compare data stored in the first storage unit to data periodically stored in the second storage unit.

7. The display device of claim 1, wherein the liquid crystal display is capable of receiving data corresponding to the at least one reference image and the at least one instantaneously captured image and displaying the at least one reference image and the at least one instantaneously captured image.

8. The display device of claim 1, further comprising a control circuit connected between the comparison circuit and the liquid crystal display, wherein the comparison circuit compares data corresponding to the at least one reference image to data corresponding to the at least one instantaneously captured image to generate a comparison result, according to which the control circuit generates a control signal to the liquid crystal display.

9. The display device of claim 8, further comprising a switch connected to the comparison circuit, configured for storing data corresponding to the reference image into the comparison circuit instantaneously when the switch is operated.

10. A display device comprising:
a monitor;
a camera;
a comparison circuit connected to the camera; and
a control circuit connected to the control circuit and the monitor;
wherein the camera is capable of capturing a plurality of instantaneously captured images periodically, the comparison circuit is capable of generating a positive result when one of the instantaneously captured images matches a pre-stored reference image and generating a negative result when no instantaneously captured images match the reference image, and the control circuit is configured for generating a first instruction to turn on the monitor according to a positive comparison result and to turn off the monitor according to a negative comparison result.

11. The display device of claim 10, wherein the comparison circuit comprises a first storage unit configured for storing data corresponding to the reference image, a second storage unit configured for storing data corresponding to the most recent instantaneously captured image, and a data processing unit configured for comparing the data stored in the first storage unit and the data stored in the second storage unit so as to generate a comparison result.

12. The display device of claim 10, wherein the monitor is one of a cathode ray tube display and liquid crystal display.

13. The display device of claim 11, wherein the first storage unit is configured for pre-storing a plurality of reference images corresponding to different authorized users, respectively.

14. The display device of claim 11, wherein the data processing unit compares the instantaneously captured image to the reference images one by one, and the data processing unit generates a positive comparison result when the instantaneously captured image matches one of the reference images, and a negative comparison result when the instantaneously captured image matches none of the reference images.

15. The display device of claim 11, further comprising a switch connected to the first storage unit, wherein the switch is operable to direct the camera to capture an image as one of the reference images.

16. The display device of claim 10, wherein the camera is further connected to the monitor, the monitor being capable of displaying images captured by the camera.
